(19) United States
(12) Patent Application Publication
(10) Pub. No.: US 2014/0259919 A1
(43) Pub. Date: Sep. 18, 2014

(54) CONFIGURABLE MODULAR ROOFTOP FARMING SYSTEM

(71) Applicant: NICHOLAS HALMOS, SANTA CRUZ, CA (US)

(72) Inventor: NICHOLAS HALMOS, SANTA CRUZ, CA (US)

(21) Appl. No.: 13/843,674

(22) Filed: Mar. 15, 2013

(51) Int. Cl. A01G 31/02

(52) U.S. Cl. CPC A01G 31/02
USPC 47/62 C; 47/62 R; 47/59 R

(57) ABSTRACT

A modular hydroponic growth system and method for roof top farming. The system includes a nutrient solution reservoir and preferably at least one plant growth module. Each module may be repositioned upon a roof top to distribute higher weight-density components over strong points or legally specified areas of the roof. A frame preferably using industry standard components is joined with the system modules to increase the stability of a resulting aggregated structure. The water reservoir may alternatively be configured to circulate water through one or more growth modules or to simply deliver water through channels to the growth modules. The frame may optionally be affixed or attached to the roof top.

### FIELD OF THE INVENTION

The present invention generally relates to hydroponic farming and more particularly to hydroponic systems and methods of use applicable to roof top farming.

### BACKGROUND OF THE INVENTION

The subject matter presented in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The prior art has many limitations in addressing numerous issues in designing, installing, maintaining and reconfiguring roof top hydroponic systems, including (i) conforming to weight bearing limitations, both structural and regulatory, imposed on roof top equipment installations; (ii) coping with the relative susceptibility and fragility of individual pieces of equipment to wind damage and seismic events; (iii) adapting equipment siting, orientation, and configuration to accommodate obstructions commonly found on rooftops; (iv) conforming to building codes that are imposed on the basis of business use cases and in light of broadly applied zoning-based regulations; (v) converting or redesigning tools, methods, and equipment that were originally developed in, and to best support, large ground based green house installations to roof top environments where space is precious and available floor space is comparatively less contiguous; (vi) addressing the needs of real estate owners and property managers to have flexibility to rapidly respond to unforeseen urgencies in equipment placement, reconfiguration, disassembly and removal; and (vii) avoiding the increased demands of maintaining and using large equipment, to include modular equipment sizes, that is exposed to the natural elements and in the restrictive setting of a roof top.

There is therefore a long-felt need to provide hydroponic systems that are more effectively and more efficiently configurable and reconfigurable on roof tops and other locations that are exposed to the elements and commonly present obstructions or regulations that limit equipment placement choices.

### SUMMARY AND OBJECTS OF THE INVENTION

Toward these and other objects that are made obvious in light of the present disclosure, a method and system are provided that enable a modular deployment of an invented hydroponics system on a rooftop and locations with limitations of equipment placement choice.

It is an object of the present invention to provide a modular hydroponics system that is more adaptable to roof top placement. In one aspect of the method of the present invention (hereinafter, “the invented method”) a nutrient solution reservoir and at least one growth module are positioned on a roof top such that the higher weight density components are positioned at locations on the roof top that are rated to support higher loads.

In another optional aspect of the invented method, one or more growth modules are mechanically coupled with the fluid reservoir to establish a unified assembly, whereby the unified assembly is more resistant to environmental damage and shock than isolated modules and reservoirs. The unified structure can also be affixed to a rooftop with fewer attachment points than if each individual element of the system was affixed independently.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

The invention is pointed out with particularity in the appended claims. The advantages of this invention described above, and further advantages, may be better understood by reference to the following description taken in conjunction with the accompanying drawings, in which:

FIG. 1A is a perspective view of an invented hydroponics system positioned on a rooftop, the invented hydroponics system including a nutrient solution reservoir and a growth module;

FIG. 1B is a block diagram of the essential components of the invented hydroponic system of FIG. 1A;

FIG. 2A is a top view of the rooftop of FIG. 1A and the nutrient solution reservoir and eight growth modules;

FIG. 2B is a top view of the rooftop of FIG. 1A wherein the nutrient solution reservoir and eight growth modules are attached to a first frame;

FIG. 2C is a top view of the rooftop of FIG. 1A wherein the nutrient solution reservoir and eight growth modules are attached to a second frame;

FIG. 2D is a top view of the rooftop of FIG. 1A wherein the nutrient solution reservoir and eight growth modules are attached to a third frame;

FIG. 3A is a perspective view of the first invented system of FIG. 1A having all four legs coupled to a pair of strut lengths;

FIG. 3B is a perspective view of the first invented system of FIG. 1A having only two legs coupled to a single strut length;

FIG. 4A is a top view of a second rooftop having preferred equipment locations and obstructions;

FIG. 4B is a top view of the second rooftop of FIG. 4A with a fourth frame configuration;

FIG. 4C is a top view of the second rooftop of FIG. 4A and fourth frame of FIG. 4B coupled with a plurality of growth modules and nutrient solution reservoirs of FIG. 1;

FIG. 5 is a top view of a third rooftop and a fifth frame coupled with a second plurality of growth modules and nutrient solution reservoirs of FIG. 1;

FIG. 6 is a top view of a second invented system that includes a nutrient reservoir, two growth modules and system tubing of FIG. 1;

FIG. 7 is a detailed view of a first leg applied to couple a growth module of FIG. 1A to the first frame of FIG. 2B;

FIG. 8A is a detailed view of a second coupling assembly applied to couple a growth module of FIG. 1A to the third frame of FIG. 2D at a central point of the growth module;

FIG. 8B is a detailed view of the first leg of FIG. 7 adapted to couple a growth module of FIG. 1A to the third frame of FIG. 2D at a central point of the growth module;

FIG. 9 is a detailed side view of a plurality of tubing protectors that couple to the frame of FIG. 2B to provide support for the system tubing of FIG. 1A; and

FIG. 10 is perspective view of the exemplary first strut element of FIG. 2C with fastener bolts 22 and as installed in the first roof of FIG. 2A;

FIG. 11 is a detailed, cut-away side view of a parapet anchor of FIG. 4B.

### DETAILED DESCRIPTION

It is to be understood that the present invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

FIG. 1A is a perspective view of a first preferred embodiment of the invented hydroponic system 2, or first system 2. The first system 2 includes a nutrient solution reservoir 4, a growth module 6 and system fluid tubing 8. The nutrient solution reservoir 4 (hereinafter, “reservoir” 4) includes suitable prior art plumbing and electrical equipment to provide a flow of a solution of dissolved nutrients and water to the cultivation module 6 (hereinafter, “module” 6). The reservoir 4 may comprise (a.) an electrical pump adapted to accept electrical power from an external source and/or electrical power from an electrical battery; (b.) a water volume; (c.) nutrients and one or more nutrient dispensing modules; (d.) pH balancing chemicals and pH balancing chemical dispensers; and (d.) tubing sufficient to deliver the solution of water, nutrients and pH balancing chemicals to the connecting system fluid tubing 8.

The module 6 comprises a cultivation chamber 6A having a plurality of box legs 7A-7D and a fluid distribution manifold 10. The box legs 7A-7D are preferably individually height adjustable in order to allow the growth module 4 be positioned on uneven surface while allowing the cultivation chamber 6A to optimally orient an internal cultivation volume to support ebb and flow dynamics of the nutrient solution. A removable tubing cap 10A fits onto a channel outlet 10B of the fluid distribution manifold 10 of the growth module 6 to avoid loss of the nutrient solution.

Referring now to FIG. 1B, FIG. 1B is a block diagram of components of the invented hydroponic system 2. The reservoir 4 maintains a nutrient solution source 200 and provides access to the nutrient solution source 200 to the pump 202 for distribution of nutrient solution through a solution channel 204 and into a growth volume 206 that is hospitable for plant growth. The growth module 6 provides an enclosure 208 that defines the growth volume 206. Preferably the pump 202 is motorized and includes either a battery (not shown) or an electrical power connector 210, wherein the electrical power connector 210 is adapted to couple with an external electrical power source (not shown). It preferable that the solution channel 204 be detachably coupleable with the both the nutrient solution source 200 and the enclosure 208, whereby a length of the solution channel 204 may be sized in length, or cut to a desired length to enable a preferred placement of the nutrient solution source 200 and the enclosure 208.

Referring now to FIG. 2A, FIG. 2A is a top view of a second preferred embodiment of the invented system 12, or second invented system 12, positioned on a first rooftop 14. The second invented system 12 includes a reservoir 4 and eight growth modules 6 coupled with additional elements of system fluid tubing 8 (hereinafter, “system tubing” 8). The system tubing 8 provides a channel that enables the reservoir 4 to deliver the nutrient solution to the growth modules 6, where it is used to hydrate and nourish plant growth within the cultivation chamber 6A, and optionally to return nutrient solution back to the reservoir 4. The system tubing 8 couples with the fluid distribution manifold 10 of each growth module 6. An access door 6B of the growth module 6 is removably coupled to partially enclose the cultivation chamber 6A with quick disconnect fasteners 6C.

Referring now to FIG. 2B, FIG. 2B is an alternate pattern of strut elements 16 that are coupled to reservoir 4 and the growth modules 6 and thereby provide the second invented system 12 with a first unified frame 18. The strut elements 16 include strut lengths 20 of different sizes and fasteners 22 that join the strut lengths 20 together. The strut lengths 20 may be or comprise metallic struts, beams, or rails, to include framing and strut components marketed by Atkore Corporation of Harvey, Il in the UNISTRUT™ framing materials product lines, and other suitable framing and construction components known in the art. The fasteners 22 may comprise nails, screws, bolts, clips, brackets and other suitable fasteners and fastener assemblies known in the art. Fasteners 22 are applied to both couple strut lengths 20 together and to couple the reservoir 4 and the growth modules 6 to the strut lengths 20. The reservoir 4 and each growth module 6 are each coupled to at least two strut lengths 20 of the first unified frame 18.

Referring now the FIG. 2C, FIG. 2C is a top view of an alternate arrangement of the second invented system 12 wherein the strut lengths 20 are shaped into a first strut length 20A and a second strut length 20B of a second unified frame 24. Each strut length 20A & 20 B couples with only one side of four growth modules 6. The first and second strut lengths 20A & 20B are both coupled to the reservoir 4.

Referring now to FIG. 2D, a third frame 26 provides five strut lengths 20C-20G that are coupled together with fasteners 22 and are additionally coupled to a central point of each of the growth modules 6 and the reservoir 4.

Referring now to FIG. 3A, FIG. 3A is a perspective view of the first invented system 2 coupled to a pair of strut lengths 20A & 20B at box legs 7A-7D by fasteners 22. The strut lengths 20A & 20B may be or comprise UNISTRUT™ P1000 series products and/or other suitable struts or framing materials known in the art. A first pair of box legs 7A & 7D are coupled to the strut 20A and a second pair of box legs 7B & 7C are coupled to the strut 20B.

Referring now to FIG. 3B, FIG. 3B is a perspective view of the first invented system 2 coupled to the eighth strut length 20H by bolts 22A and brackets 22B. The first pair of box legs 7A & 7C and the reservoir 4 are both coupled to the eighth strut 20H. The second pair of box legs 7B & 7D are not attached directly to a strut length 20.

Referring now to FIG. 4A, FIG. 4A is a top view of a second roof 28. The second roof 28 presents a plurality of features, to include preferred equipment spots 28A for placement of heavier equipment, e.g., reservoirs 4, waste heat vents 28B, chilled air vents 28C, and various obstructions 28E to equipment placement, e.g., access doors, HVAC equipment, weak spots that are unsafe to place equipment upon, chimneys, and pipes. It is understood that at least the preferred equipment spots 28A that as desirable for placement of reservoirs 4 may be centered over structural elements of a host building, such as structural columns and beams. It is further understood that certain obstructions 28E may be defined by laws, regulations and best practices wherein no physical obstruction need be present to prohibit authorization to position equipment at certain spots or areas of the second roof 28.

Referring now to FIG. 4B, FIG. 4B is a top view of the second roof 28 wherein a plurality of strut lengths 20 are positioned and coupled together by fasteners 22 to form a fourth frame 30. The fourth frame 30 is patterned and prepositioned for coupling with reservoirs 4 and growth modules 6. It is understood that the method of the present invention enables flexible siting of the invented system 2 to enable desirable placements of the invented system 2 proximate to waste heat vents 28B and chilled air vents 28C, whereby heat exchange equipment may be applied for use with the invented system 2.

FIG. 4B also shows weights 32, e.g., sand bags, that are placed upon or coupled to the strut lengths 20 provide additional stability and resistance to wind force and seismic events to the fourth frame 30 and the reservoirs 4 and growth modules 6. In addition, parapet anchors 34 couple the fourth frame 30 to a parapet 28P of the second roof 28 and increase the stability of the fourth frame 30 while mitigating the necessity of penetrating a substantively horizontal surface of a roof with fasteners.

Referring now to FIG. 4C, FIG. 4C is a top view of twenty one growth modules 6 and four reservoirs 4 coupled to the fourth frame 30.

Referring now to FIG. 5, FIG. 5 is a top view of a third roof 36 having a plurality of obstructions 36A wherein a fifth frame 38 is coupled with thirty seven growth modules 6 and five reservoirs 4. It is noted that several growth modules 6 of FIG. 5 are coupled to the fifth frame 38 at all four legs 7A-7D, but that certain growth modules 6 are coupled to the fifth frame 38 at either a pair of box legs 7A& 7D or 7B & 7C or at a central point of a growth module 6.

Referring now to FIG. 6, FIG. 6 is a top view of a third invented system 42 that includes a reservoir 4, two growth modules 6 and system fluid tubing 8. Separate lengths 8A & 8B of system fluid tubing 8 respectively couple (a.) the reservoir 4 to the fluid distribution manifold 10 of a first growth module 6; and the fluid distribution manifold 10 of the first growth module 6 to a fluid distribution manifold 10 of a second growth module 6, whereby nutrient fluid may be delivered to both growth modules 6 and optionally circulated back into the reservoir 4.

FIG. 7 is a detailed view of an exemplary attachment of a first leg 7C of the growth module 6 to a strut element 20. An upper leg element 700 presents an aperture through which a first bolt 702 extends. Each bolt 702 also extends through an intervening leg element 704 and is secured in place by a nut 706. The intervening leg element 704 is secured to the strut element 20 by a bracket 708. Vertical adjustment of each leg 7A-7D of each growth module 6 may therefore be achieved by selectively positioning and bolting the intervening leg element 704 to the upper leg element 700. Positioning of the leg within a frame 18, 24, 26 30 & 38 is achieved by selecting where in the selected frame to the couple the leg 7C to a strut 20 by means of the leg bracket 708.

The elements 700-710 of FIG. 7 may be selected from suitable leg and fastener elements known in the art, to include UNISTRUT™ Part Numbers P9200, P9000, and P1747, or other suitable adjustable leg and fastening products and equipment known in the art.

FIG. 8A is a detailed view of a central coupling assembly 800 applied to couple a central fixture 6C of a growth module 6 to an exemplary strut length 20 of the third frame 26. The central coupling assembly 800 is a cable tightening system that includes a cable 802 and a cable turnbuckle 804. Alternate manual rotating of the turnbuckle 804 about the cable 802 enables the cable 802 to be alternately tightened or loosened in reference to the coupled growth module 6 and the exemplary strut length 20. A pair of pad eyes 806 & 808 respectively couple the cable 802 to the growth module 6 and the length 20 by attachment with bolt and nut assemblies 706 &702.

FIG. 8B is a presentation of a leg assembly 7A as an alternative central coupling assembly 810.

FIG. 9 is a detailed perspective view of tubing protectors 900 that couple the system fluid tubing 8 to a frame 18, 24, 26, 30, & 38 and supports a coupling of the reservoir 4 with a plurality of growth modules 6. The system fluid tubing 8 is a water channel and enables the reservoir 4 to deliver the nutrient solution to the growth modules 6, and optionally enables drainage of nutrient solution from a plurality of growth modules 6 and into the reservoir 4. One or more tubing protectors 900 may be or comprise a UNISTRUT Part No. 2.5-SB-H™ single base trapeze or other suitable tubing protectors known in the art.

Referring now to FIG. 10, FIG. 10 is perspective view of an exemplary strut element 20 with fasteners 22 and as installed in the first roof 14.

FIG. 11 is a side cut-away view of a parapet anchor 34, consisting of a parapet anchor bracket 34A securing an exemplary strut length 20E to the parapet 28P of the second roof 28 using mechanical fasteners 34B.

The present invention provides many benefits over the prior art of rooftop farming systems, such as offering (i) closed loop hydroponics that allows for efficient use of water resources, (ii) Ebb and Flow style irrigation so the same water mass can be used for selective zone irrigation which can reduce the aggregate weight profile of an installed system (iii) a greenhouse type controlled environment that provides improvements in production/resource efficiency and can extend growing seasons as compared to “green roof” type, open air rooftop farming systems, (iv) a controlled environment that can be operated without requiring human presence inside the cultivation area, thus creating significant weight savings and avoiding a myriad of building code, workplace safety, and other regulatory challenges that arise in rooftop installations of conventional greenhouses, (v) distributed water weight management, through installation of multiple small reservoirs instead of a single large reservoir, that mitigates structural stresses on a host building (vi) modular configuration and framing options create the ability to place invented systems 2 in close proximity to sources of waste heating and cooling, e.g., building vents, and allows a roof top farm to be broken into small clusters that separately fit into the “nooks and crannies” of the urban landscape (vii) low profile invented systems 2 that are more aerodynamic than conventional greenhouses which reduce wind loading forces and low profile invented systems 2 that can be camouflaged easier to mitigate aesthetic objections from historic commissions or neighbors (ix) modular growth modules 6 allow for farm expansion and contraction on a linear scale.

The foregoing disclosures and statements are illustrative only of the Present Invention, and are not intended to limit or define the scope of the Present Invention. The above description is intended to be illustrative and not restrictive. Although the examples given herein include many specificities, they are intended as illustrative of only certain possible configurations or aspects of the Present Invention. The examples given should only be interpreted as illustrations of some of the preferred configurations or aspects of the Present Invention and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

We claim:

1. A roof top hydroponics system comprising:
a growth module adapted to provide internal conditions hospitable for plant growth; and
a nutrient solution reservoir, the nutrient solution reservoir adapted to deliver nutrient solution to the growth module.

2. The roof top hydroponics system of claim 1, further comprising fluid channeling coupled with the nutrient solution reservoir and the growth module, wherein the fluid channeling is adapted to enable the circulation of water and nutrients from the water reservoir and to the growth modules.

3. The roof top hydroponics system of claim 2, wherein the fluid channeling comprises tubing.

4. The roof top hydroponics system of claim 3, wherein the reservoir is further adapted to circulate water through the tubing to and from the growth module.

5. The roof top hydroponics system of claim 1, further comprising a frame coupled to both the water reservoir module and growth module.

6. The roof top hydroponics system of claim 5, further comprising a roof attachment feature coupled with frame, the roof attachment feature adapted to secure the frame to a roof.

7. The roof top hydroponics system of claim 6, further comprising a plurality of roof attachments, each roof attachment feature coupled with the frame, and each roof attachment feature adapted to secure the frame to the roof.

8. The roof top hydroponics system of claim 5, further comprising additional weights coupled to the frame and thereby adding to the inertial force of the frame.

9. The roof top hydroponics system of claim 1, further comprising a plurality of growth modules adapted to receive nutrient solution form the nutrient solution reservoir.

10. The roof top hydroponics system of claim 9, further comprising fluid channeling coupled with the nutrient solution reservoir and the plurality of growth modules, wherein the fluid channeling is adapted to enable the circulation of water and nutrients from the water reservoir and to the plurality of growth modules.

11. The roof top hydroponics system of claim 10, wherein the fluid channeling comprises tubing.

12. The roof top hydroponics system of claim 11, wherein the reservoir is further adapted to circulate water through the tubing to and from the growth module.

13. The roof top hydroponics system of claim 9, further comprising a frame coupled to both the water reservoir module and each of the plurality of growth modules.

14. The roof top hydroponics system of claim 13, further comprising a roof attachment feature coupled with frame, the roof attachment feature adapted to secure the frame to a roof.

15. The roof top hydroponics system of claim 14, further comprising a plurality of roof attachments, each roof attachment feature coupled with the frame, and each roof attachment feature adapted to secure the frame to the roof.

16. The roof top hydroponics system of claim 9, further comprising additional weights coupled to the frame and thereby adding to the inertial force of the frame.

17. A method of roof top farming, the method comprising:
a. placing a growth module upon a roof top, the growth module adapted to provide a hospitable internal volume for plant growth;
b. placing a nutrient solution reservoir upon the roof top, the nutrient solution reservoir adapted to deliver a nutrient solution to the growth module; and
c. coupling the nutrient solution reservoir to enable the nutrient solution reservoir to provide nutrient solution to the plurality of growth modules.

18. The method of claim 17, further comprising placing a plurality of growth modules upon roof top, each growth module adapted to provide a hospitable internal volume for plant growth.

19. The method of claim 18, further comprising:
d. routing a frame upon the roof top; and
e. mechanically coupling the nutrient solution reservoir and the plurality of growth modules to the frame to form a unified structure, whereby the unified structure aggregates the inertial resistance of the nutrient solution reservoir and the plurality of growth modules against displacement by wind and seismic forces.

20. The method of claim 19, further comprising securing the frame to a structural feature of the roof top.

21. The method of claim 18, further comprising placing the nutrient solution reservoir at a structural strong point of the roof top.
